(19) United States
(12) Patent Application Publication
(10) Pub. No.: US 2017/0336770 A1
(43) Pub. Date: Nov. 23, 2017

(54) SYSTEM AND METHOD FOR CONROLLING ENERGY CONSUMING DEVICES WITHIN A BUILDING

(71) Applicant: Switchee Limited, Bristol (GB)

(72) Inventor: Russell MACMILLAN, Bristol (GB)

(73) Assignee: Switchee Limited, Bristol (GB)

(21) Appl. No.: 15/536,131

(22) PCT Filed: Dec. 29, 2015
(86) PCT No.: PCT/GB2015/054173

§ 371 Date: Jun. 15, 2017

(30) Foreign Application Priority Data
Dec. 27, 2014 (GB) 1423260.7

(51) Int. Cl. G05B 19/042; G05B 19/048

(52) U.S. Cl. CPC G05B 19/042; G05B 19/048; G05B 2219/2642

(57) ABSTRACT

The invention provides a control arrangement and corresponding method for intelligent control of at least one energy consuming device within a building. The control arrangement comprises a switch component for controlling a first energy consuming device such as a lighting device, heating, ventilation or security device; and/or a computer-implemented control component for intelligently controlling at least one further energy consuming device, such as a heating, air conditioning, ventilation or security apparatus. The switch component and/or the control component are provided within a housing which is mounted within or interfaced to a pattress or wiring box during use. The control component comprises a microprocessor and suitably arranged software configured to receive sensor data obtained from one or more sensors provided in or on the housing, and/or process the sensor data to enable the system to intelligently control the at least one further energy consuming device. The system is configured to build a model of a building occupant's behaviour so that the energy consuming devices can be controlled more efficiently and intelligently. The invention is simple and easy to install because it replaces an existing light switch or thermostat.

The present invention relates to systems and methods for the monitoring and control of energy consuming systems or other resource-consuming systems, and also to systems which provide residential and commercial property management services. In particular, the invention relates to the governance and intelligent control of heating systems, air conditioning systems, cooling systems, lighting systems and household or consumer devices within both residential and commercial property. It also relates to property management services such as fault reporting, automatic building monitoring or building system fault detection, occupant notifications, messaging and rent reminder or account services for building occupants. The invention encompasses sensory technology to gather signals indicative of an environmental condition, data processing technology, display devices, communications equipment and user interfaces. The invention may be viewed as providing an intelligent, autonomous energy control solution. It may also be viewed as providing an enhanced solution for property management or control, and a solution for enhancing efficient energy consumption within a building.

Home automation systems and technology to control household devices are well developed fields. An ambition or aspiration to reduce carbon dioxide emissions is driving the emergence of new technologies to reduce energy consumption by optimising the use of building infrastructure and systems to better match the needs of the building users. In particular, substantial increases in energy efficiency can be achieved through better control and governance of building heating, cooling and lighting systems.

Previous inventions or systems within these broad categories might include intelligent thermostats, modular home automation systems and controllers, software based home automation solutions or smart energy meters.

Current control and automation systems generally rely on the combination of a network of sensors, decision making devices and actuators to provide usable functionality. Sensory devices might include presence detection, movement detection, temperature sensing, ambient light sensing or humidity monitoring whilst actuators might control lights, heating systems or cooling systems.

Current systems which comprise a single standalone device generally only provide one function, for example control of a heating system delivered by a thermostat or actuation of a light delivered by a light switch (either ‘dumb’ or intelligent). Nothing currently exists which provides wide ranging building automation and property management functionality in a single standalone unit which can operate autonomously from other devices. Previous solutions therefore generate unnecessary system complexity and preclude the sharing and aggregation of data between functions—one or more such issues being at least partially resolved by an embodiment of the present invention described herein.

Current control systems rely on simple user interfaces often structured around simple time-triggered rules or the measurement of a single parameter (for example, temperature or power consumption). Such systems do not adapt to frequent changes in occupant behaviour which means that heating, cooling or lighting systems are un-necessarily activated when either a part or the whole of the building is unoccupied. This wastes significant amounts of energy un-necessarily. It would be better if the information required to program a system were structured around user lifestyle questioning such as the time that a user wakes up or the time that they leave for work. Using this information and information gathered from its own capabilities, it would be preferable if the system autonomously adapted in response to real-time user behaviour to minimise energy consumption and improve occupant comfort.

Previous systems to control heating or cooling systems are often unable to collect any environmental or user behaviour data beyond the limited parameters required to control a heating or cooling system in a basic manner.

Previous systems which are based around a microprocessor controller often require an external connection to receive data from the Internet or a wide area network (for example external weather forecast information or connection with an Internet based account) and cannot function without such connectivity. This limits the numbers and types of buildings within which the system can operate to those which can offer such connectivity.

Previous systems often require physical wiring or cabling to operate. Furthermore, the form and dimensions of prior systems are often specific to the electrical infrastructure of one region or country—for example the size and shape of electrical outlets and switches. Many require specific power sources or harvest power from an actuated control line when the system is either in the On or Off state. This increases the cost of installation significantly and can impose a limitation where the system is designed for one particular wiring configuration or one type of infrastructure. It is more desirable that a system is adaptable to different wiring configurations and infrastructure and that the control system accommodates simple do-it-yourself installation.

The majority of previous systems rely on a mechanical interaction with the user during operation—for example push buttons, dials or levers. Mechanical components such as this are often susceptible to damage through incorrect operation and suffer wear and tear more easily.

Traditional thermostat control devices using both mechanical (bi-metallic strip) and electronic temperature sensors cannot generally be situated in certain locations owing to their susceptibility to a temporary cold or warm air ‘draft’ altering their surrounding environment and therefore decision making process when, for example, a door is opened for the occupant to enter or exit. It would be preferable if these systems were immune to such temporary temperature effects so that they could be positioned in more convenient locations within the house.

Thus, it is desirable to provide an intelligent home automation system which alleviates or eliminates the disadvantages associated with the prior art. Such an improved solution has now been devised. Embodiments of the present invention are defined in the appended claims.

An embodiment of the present invention provides the benefit of wide ranging building system control and property management functionality by combining control of a plurality of energy consuming devices or systems, such as air conditioning systems (heating, cooling or both) and the control of lighting systems. The user may interact with the system through an intuitive user interface which may provide other value-added services to both tenants, landlords, building managers and owner-occupiers. The system also generates and/or collects a wide range of data that can be used to enable better property management services, and more intelligent and efficient control of building resources and apparatus.

An embodiment of the present invention solves the problem of the complexity and fragmentation of current automation solutions by combining all of the sensing, communication, decision making and output or actuator technology that is necessary to provide full home automation functionality. This functionality may be embodied so that it may directly replace a light switch or thermostat in all regions of the world and make use of existing wiring and infrastructure. Such an embodiment may include a two-part mechanical interface between the invention and the building infrastructure.

The invention enables the energy consuming devices to be operated intelligently in response to some sort of signal indicative of an environmental condition, or in response to simple user interaction via a switch, touch or gesture input system (which still goes ‘through’ the microprocessor before being acted upon).

The invention may provide heating and/or lighting control. Some instantiations may also control cooling systems, provide security system functionality and/or allow for remote access. By combining functionality to control one or more system, the invention is able to monitor user behaviour and/or cross reference information from different functions to improve its control functionality. For example, if the user were to arm a security system, the invention would know that a building or zone was unoccupied.

The system may pre-process measured temperature information to filter out temporary effects caused by, for example, a draft of cold or hot air as an external door to the property is opened. This improves the flexibility in where the unit can be installed.

An electronic display and/or advanced user interface may be used to provide a platform for enhanced building management services such as automatic fault detection, energy consumption monitoring and/or user behaviour monitoring. This provides additional value-added services relating to building management which are not currently available within traditional automation solutions. These services might include an interface between the building user and the building operator, manager or landlord through which messages can be exchanged, rent reminders can be issued, services can be requested and/or advertising can be distributed. Data is collected from sensors associated with the invention and used to assist in property management—for example, by predicting system or building faults and assisting with preventative maintenance, using occupancy data to better schedule visits to properties and using a variety of sensor data to analysis how a building is being used for the purposes of detecting, for example, tenancy fraud or property mis-use. Building or system faults may be reported by the user to the organisation responsible for maintenance. Heating or cooling system functionality can also be disabled or limited remotely, via the management interface and/or communications link. This might be used where a mandated safety check is overdue that requires the building occupant to cooperate and/or grant access to the property. Further, data can be used by property managers to assist in targeting their capital investment programmes—for example, by targeting it towards properties which have had the most use or where certain rooms have been used more than others.

An embodiment of the present invention may also be used to assist in the protection of vulnerable people by using its sensor data to detect occupant incapacitation, for example through a fall, or other safety related issues to which a response can be summoned.

An embodiment of the present invention may be comprise an intuitive user interface structured around lifestyle questions from which appropriate control scenarios can be established. For example the user (building occupant) might be asked what time they go to bed or go to work, and/or what type of lifestyle they adopt. Thus, information may be explicitly inputted into the system so that knowledge of the user's behaviour can be used to adapt the way in which the devices in the building are controlled. In other embodiments, this knowledge can be inferred or calculated by the system itself. The interface may also be used to transmit data back to the user to encourage them to modify their behaviour—for example, personalised energy saving tips may be presented based on observed behavioural or usage patterns. This is an improvement over current methodologies which involve simply programming the time and temperature parameters of the heating or cooling system.

An embodiment of the present invention may include one or more methods of communication although it may be able to operate entirely autonomously without external connectivity or data. Both an internet based and a mobile phone network based communication system may be available to cater to different operating environments. The unit may also operate by communicating with additional replica units, or communication with other home automation technologies through the use of established and/or bespoke wireless or wired protocols. Such protocols may include wifi, zwave, zigbee, X10, iBeacons etc. However, the skilled person will appreciate that other wireless or wired communications technologies can be used.

Where an external data connection is available, for example the internet or a mobile phone or telecommunications network, the invention may be able to gather and/or make use of externally available data to further optimise its decision making. Such external data might include weather forecasts, public school holiday calendars or external data analysis capabilities.

In some configurations, the invention may be arranged to harvest (ie draw upon) power from the systems that it controls to power its internal functionality. In some configurations, the invention may be powered through existing cables within the building.

An embodiment of the present invention may have the benefit of multiple methods of user input. It may combine three dimensional gesture control with projective capacitive touch and/or touch panel technology to deliver a more robust user interface which is particularly intuitive.

Thus, in accordance with the invention there may be provided a control system. It may be termed an ‘intelligent’ control system. It may be a computer-implemented control system. It may comprise a control arrangement for controlling at least one energy consuming device within a building. Alternatively, it may comprise a control arrangement for controlling at least two energy consuming devices within a building.

The control system may comprise a switch component for controlling a first energy consuming device. It may also comprise a separate, computer-implemented control component for intelligently controlling at least one further energy consuming device.

The switch component and/or the control component may be provided within a housing. The system may further comprise software arranged to generate one or more rules for controlling the first energy consuming device and/or further energy consuming device in accordance with a behavioural pattern relating to an occupant (user) of the building.

The invention may be arranged to learn about the user's behaviour. It may learn from their observed behaviour and from their interaction with the invention itself. For example, if the user repeatedly overrides the temperature at 9 am to make it warmer, the invention will learn this over time.

The control arrangement may comprise a unit provided at the building. The housing may form part of the unit. The unit may be in wired or wireless communication with a remote location such as a control centre. The housing may be provided within a pattress or wiring box, and/or may be configured to mate with or interface to the pattress or wiring box. The housing may be mounted in or on a building infrastructure such as a wall.

The invention may be able to control the energy consuming devices in an intelligent manner by observing occupant behaviour and activity relating to energy consumption within the building. The system may observe or discern patterns in the occupant's behaviour. By monitoring and observing user behaviour or occupancy patterns within the building, the invention can provide advantages in respect of tenancy fraud detection, crime detection (eg detecting cannabis growing within the house etc).

The first and/or at least one further energy consuming device may be a lighting device. The switch component may be a stand-alone component. The first and/or at least one further energy consuming device may be a water heating device, a heating, ventilation or air conditioning (HVAC) device or system, a consumer electronic device, or a security device.

The control component may comprise a microprocessor and/or suitably arranged software configured to receive sensor data obtained from one or more sensors provided in or on the housing, and/or process the sensor data to enable the system to intelligently control the first and/or at least one further energy consuming device.

The system may be arranged and configured to detect mould growth or environmental factors favourable to mould growth. This may be achieved by using sensors associated with the unit to gather data from the environment within the building. The sensors may gather data relating to temperature and/or RH (relative humidity). The system may be arranged to provide an alert upon detection of the mould growth or favourable conditions. The alert may be sent to a remote location (ie a location other than the building) and/or may be presented visually and/or audibly upon a device within the building.

Thus, the system may be able to trigger an alert when it is determined that the building suffers, or may be about to suffer, from mould growth. This can provide significant benefits for occupant health and welfare. The system many be able to detect when mould growth is likely due to occupant-induced problems such as poor ventilation after showering or cooking and/or problems arising from the fabric of the building eg the property is naturally damp and does not have adequate ventilation/heating/insulation. This may be achieved by detecting sudden spikes in temperature or humidity, for example. The alert can prompt investigation and rectification of the problem and in particular allows for preventative maintenance at a reduced cost to treating symptoms once they have occurred. By discerning the type of problem causing the growth, and generating an automated alert, the appropriate intervention can be deployed.

The system may be arranged and configured to generate and/or store a thermal profile of the building or part thereof. This may be achieved by observing the speed of heating and cooling of the building in response to known heat sources or loss mechanisms. The thermal profile may provide an indication of the length of time required to heat the building or part thereof from an initial temperature to a target temperature. This may be calculated in conjunction with data such as external weather temperature. This thermal profile may be used by the system when calculating when to activate the heating or cooling system to achieve a desired temperature at the desired time.

The system may be arranged and configured to monitor for activity such as movement or device usage within the building, and generate an alert when no activity has been detected within a predetermined period of time. This may be achieved by the analysis of data from one or more sensors, including, for example, passive infrared, proximity, carbon dioxide, sound or light. This may be useful, for example, to detect when a vulnerable or elderly person has become incapacitated.

The system may be arranged and configured to detect when a device is not performing as expected and generate an alert to a remote location. The device may be an energy consuming device provided at or in the building. It may be the first and/or at least one further device. The device may be, for example, a boiler or heating apparatus. For example, the invention may be arranged to detect when a water temperature or air temperature within the building fails to achieve the desired temperature. This can be indicative of a fault with the boiler or heating apparatus within the building. An automated alert may be generated. The alert may displayed on a screen associated with the unit at the building, and/or transmitted to a remote location. This provides the advantage that if equipment at the building is not performing as expected, or is about to malfunction, a technician can be deployed to investigate before more cost is incurred.

The system may be arranged and configured to detect when an occupant is not using the building as expected and generate an alert to a remote location. This may be achieved by the analysis of data from one or more sensors, including, for example, passive infrared, proximity, carbon dioxide, sound or light. This may be used, for example, to detect tenancy fraud, property misuse or to help a tenant who is wasting energy.

The system may be arranged and configured to assess when the building is likely to be occupied and/or not occupied. This may be achieved by the analysis of data from one or more sensors, including, for example, passive infrared, proximity, carbon dioxide, sound or light. This information can be used in a number of ways and if the property manager or their agent needs to visit the property for any reason, those visits can be scheduled to match predicted occupancy patterns. The system may be arranged and configured to integrate with a scheduling system. Data gathered from the building by the invention may be used to build a usage pattern which facilitates an understanding of the user's occupancy times or habits. Data relating to this may be communicated to the scheduling system. The scheduling system can feed back whether the property was occupied to the occupancy learning algorithms to improve their future predictive capability. The scheduling system may be arranged to manage and/or facilitate service, repair or maintenance visits for technicians to inspect apparatus (e.g. boiler) at the building. An advantage of this feature is that a check can be made prior to scheduling a technician's visit to the building, to predict whether the occupant is likely to be at the building at the scheduled visit time. This can save wasted time and transportation costs.

The system may be arranged and configured to provide an estimate of the thermal insulation quality within a building. This may be achieved by using sensors to measure the rate at which the building or portion thereof cools down. Insulation properties can then be inferred for the building. A measurement or estimate of the insulation properties for the building may be transmitted to a remote location. For example, the system may be configured to calculate a thermal leakage rate for the building, the calculation being performed using the internal temperature and the external temperature, and also possibly knowledge relating to the building apparatus such as whether the boiler or heating apparatus is in operation. The calculation may also be performed using a value for the volume of air within the building or portion thereof.

The system may be arranged and configured to record how many technician visits the building has required or how many maintenance failure there were within a predetermined period of time, and generate an alert when the number of visits within the period reaches a threshold. The alert may be transmitted to a remote location. Thus, the system may record the number of “interventions” a building has required. An intervention may be a technician or service engineer visit, or it may be for another purpose such as to address a complaint, collect rent, address social concerns etc.

The system may be arranged and configured to generate at least one suggestion for reducing the amount of energy consumed by the first and/or at least one further energy consuming device. These suggestions are personalised to the tenant based on their observed behaviour. The invention may therefore provide energy saving advice which may serve to motivate occupants to reduce energy consumption by calculating likely financial savings. For example, the suggestion may be to lower the temperature set point at night. The user may then reject the suggestion e.g. if they find that comfort is adversely affected. The invention may be configured to learn from this and adapt future suggestions.

The system may be arranged to present information in a colour coded manner. The colour(s) may be selected so as to influence occupant behaviour. The behaviour may relate to the occupant's use of an energy consuming device. It may relate to room temperature. For example, if the thermostat in a room is set to 19 the background or information on display of the control unit may be a pleasant green colour. Conversely, if the thermostat is set to 21 the display may be a garish yellow which occupants may find less aesthetically pleasing. Thus, occupant behaviour may be influenced to set the unit at a “good” temperature which saves energy.

The system may be arranged to collect data from at least one sensor, and use the data to measure and/or record occupancy rates within the building or part thereof. Thus, by monitoring patterns of use within a building or part thereof (eg a room) a building owner or manager can gain a more accurate insight into the usage of a building. This may assist in planning for refurbishment or development of capital investment policy. For example, rather than simply refurbishing all properties within an association after a set number of years, the invention can provide data regarding which buildings have been occupied the most and therefore need maintenance or refurbishment sooner, or vice versa. In another embodiment, the data can provide more granular information about how different rooms or zones are used within a building. For example, if a high level of use is detected in a kitchen, it may be decided that the kitchen needs refurbishment sooner than, say, the lounge. Thus, by recognising patterns of use within a building, maintenance and repair can be deployed in a more intelligent and cost-effective manner.

The system may be arranged and configured to enable a communication to be transmitted between the building and a remote location. The remote location may be a remotely located control centre, housing association, building manager etc. The communication may be an alert relating to the building or its usage, or may be a data communication to provide data to the remote location. The system may comprise:

an interface arranged to enable a user of the building to input data for transmission to the control centre, the transmission of sensor data, and/or
an interface arranged to enable a communication from the control centre to be presented to the user at the dwelling. The control component may be configured to communicate wirelessly with a receiver connected to the at least one further device to control its operation.

The control arrangement may comprise input means to enable a user to provide input to the system, preferably wherein the input means comprises a touchscreen, motion sensor and/or microphone. The control arrangement may comprise presentation means for presenting information to a user, preferably wherein the presentation means comprises a display screen and/or a speaker.

The control arrangement may be referred to as a ‘unit’ or ‘control unit’. It may comprise means for connecting to an electrical circuit provided within the infrastructure of the building such that the system is able to draw power from the circuit. Power might be harvested when that electrical circuit is active (by exploiting only part of the alternating current cycle) or when the electrical circuit is switched off, in which case power can be stored for later use in, for example, a battery. The electrical circuit may be a lighting circuit.

The control arrangement may comprise communications means for sending and/or receiving data via a telecommunications network. The communications network may be a telephone network. The invention may be able to receive and/or send data via the internet.

The invention also provides a corresponding control method. It may provide a method of controlling at least one energy consuming device within a building. It may also provide a method for controlling at least two energy consuming devices within a building. The method may comprise the steps:
removing a light switch or thermostat from a wall of the building by disconnecting the switch or thermostat from an electrical circuit; and/or
connecting the electrical circuit to a control arrangement arranged as described above in relation to the corresponding system.

The method further may further comprise the step of arranging software to generate one or more rules for controlling a first energy consuming device and/or a further energy consuming device in accordance with a behavioural pattern relating to an occupant (user) of a building.

The method may also comprise the step of attaching the housing to a pattress or wiring box which previously mated with the light switch or thermostat. The method may comprise the step of replacing the light switch or thermostat with a control arrangement as described above.

Any feature described in relation to the system(s) of the invention may also be applicable to the corresponding method and vice versa.

The invention may provide a communication system arranged to enable a communication to be transmitted between a building eg dwelling and a remotely located control centre, the system comprising:

a control arrangement arranged for communication with the control centre and/or configured to control the operation of at least one energy consuming device within the dwelling, the control arrangement having an interface arranged to enable a user of the dwelling to input data for transmission to the control centre, and/or an interface arranged to enable a communication from the control centre to be presented to the user at the dwelling.

The control arrangement may be as previously described above. The communication system may thus provide a means whereby messages or other communications may be transmitted between the control centre (eg a landlord's computer) and the dwelling. The dwelling may be a residential dwelling such as a house or a commercial dwelling such as an office.

The communication between the control centre and the building (e.g. dwelling) is preferably sent via a telecommunications network, the internet, a mobile phone network or other communication network. The communication may be transmitted wirelessly.

The control arrangement may comprise a screen such that a communication from the control centre may be displayed to the user in the dwelling. Audio means may also be provided to enable messages to be presented to the user. The screen may also enable the user to send messages to the control centre. Thus, it may be a touchscreen which allows for the input of data which may then be transmitted. Other input means may be provided in addition or instead of the touchscreen.

Thus, the system may enable the user and/or the control centre to communicate. The control centre may send alerts, warnings, advice, reminders etc to the user via the system (e.g. ‘please remember that your rent is due on Friday’). The user may send requests, information etc to the control centre (e.g. ‘the boiler needs repairing’).

Any feature described above in relation to one aspect or embodiment of the invention may also be used in respect of any other aspect or embodiment.

These and other aspects of an embodiment of the present invention will be apparent from and elucidated with reference to, the embodiment described herein. An embodiment of the present invention will now be described, by way of example only, and with reference to the accompany drawings, in which:

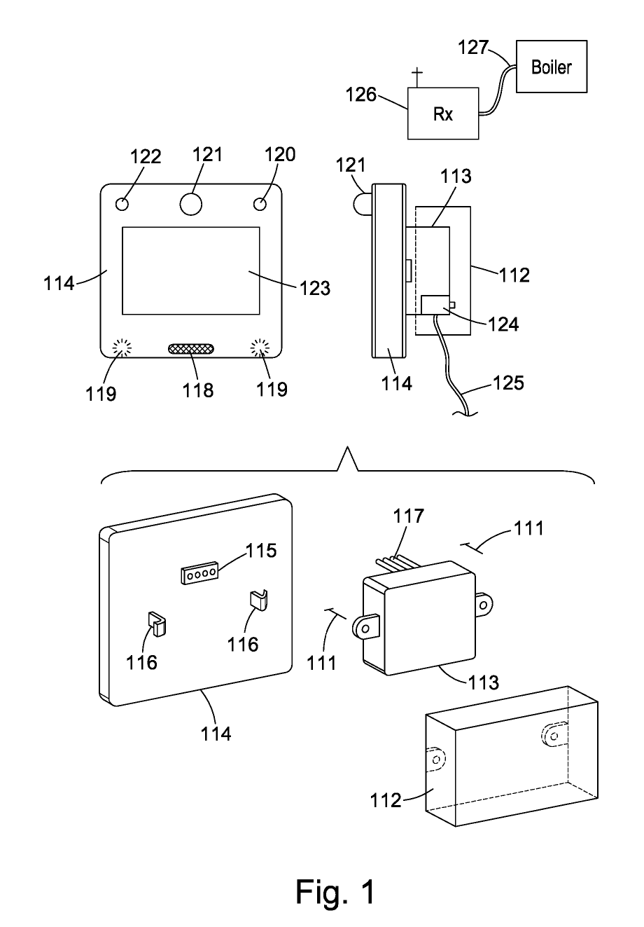

FIG. 1 is a schematic representation showing one illustrative embodiment of the invention.

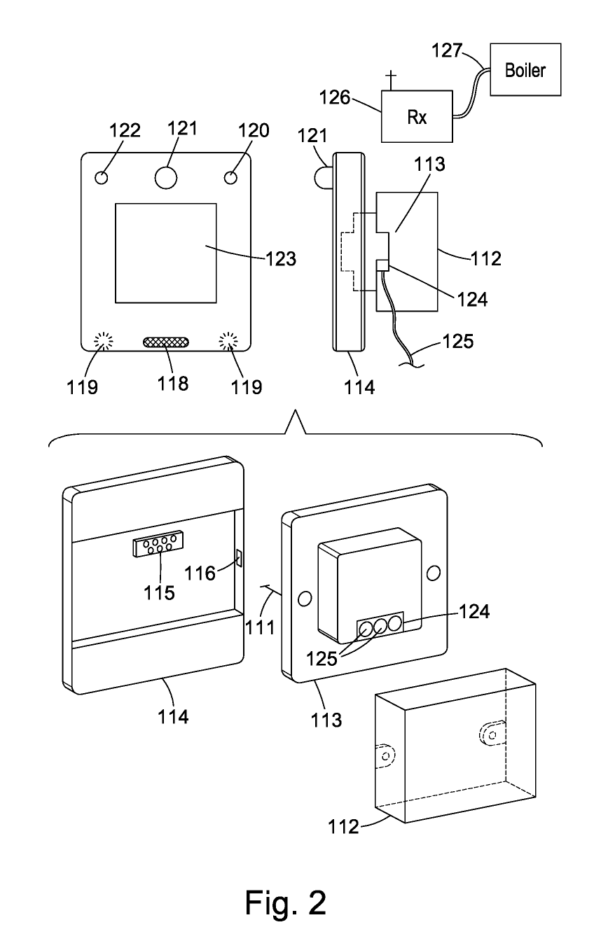

FIG. 2 is a schematic representation showing an alternative embodiment of a similar system.

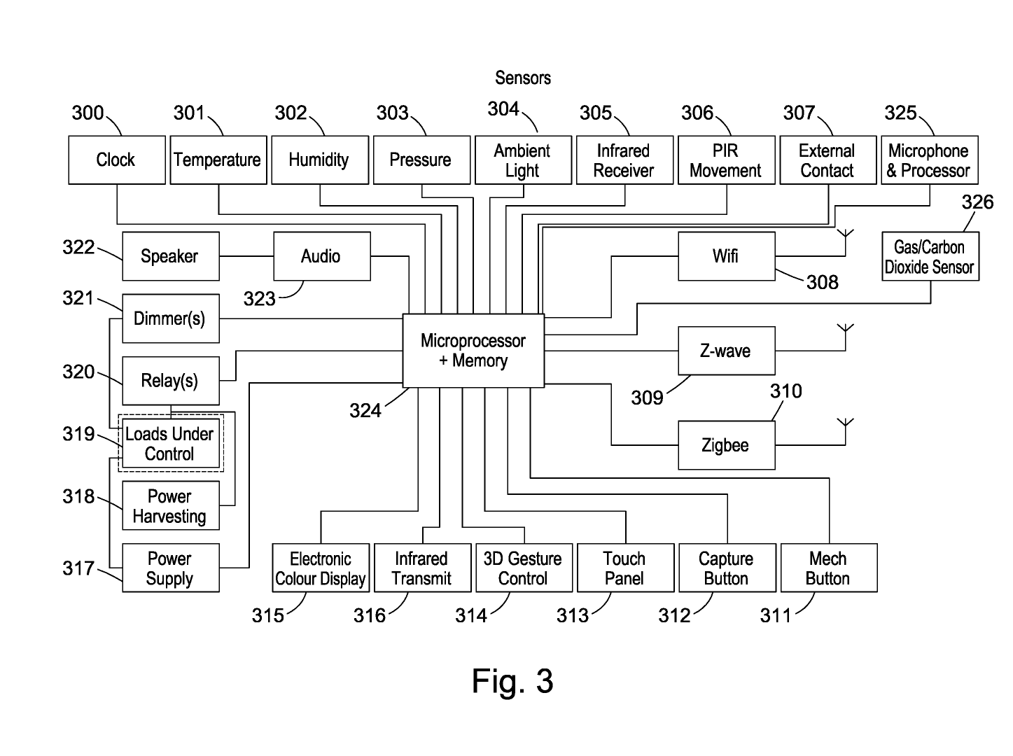

FIG. 3 is a schematic representation showing the main components within an illustrative embodiment of the invention.

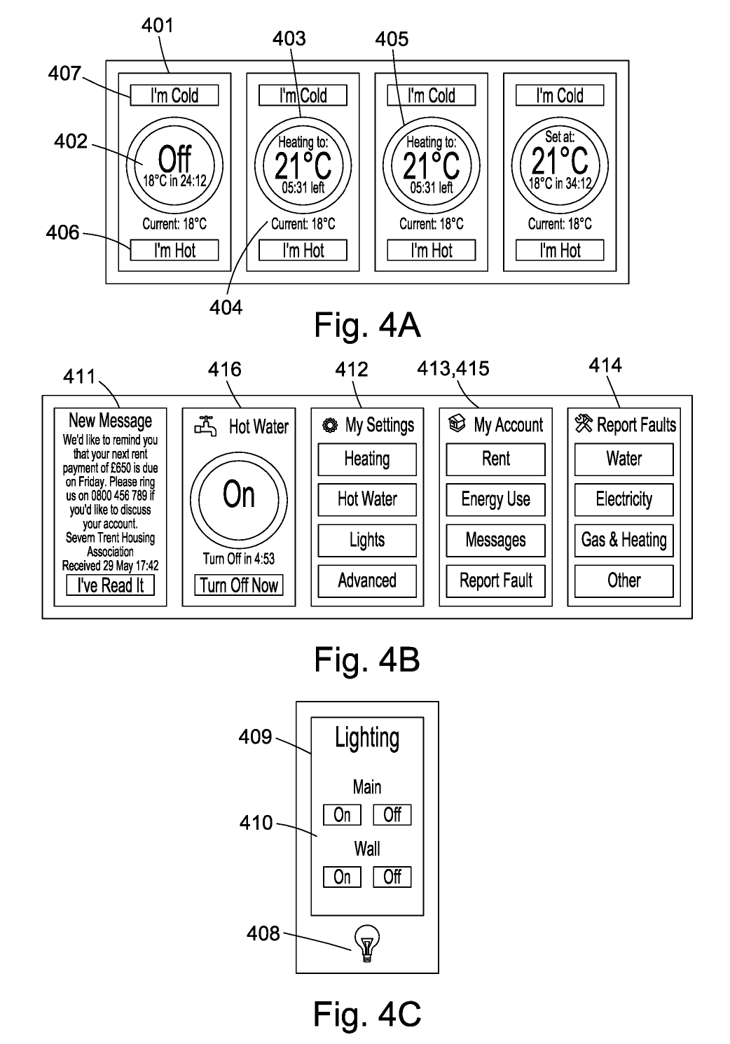

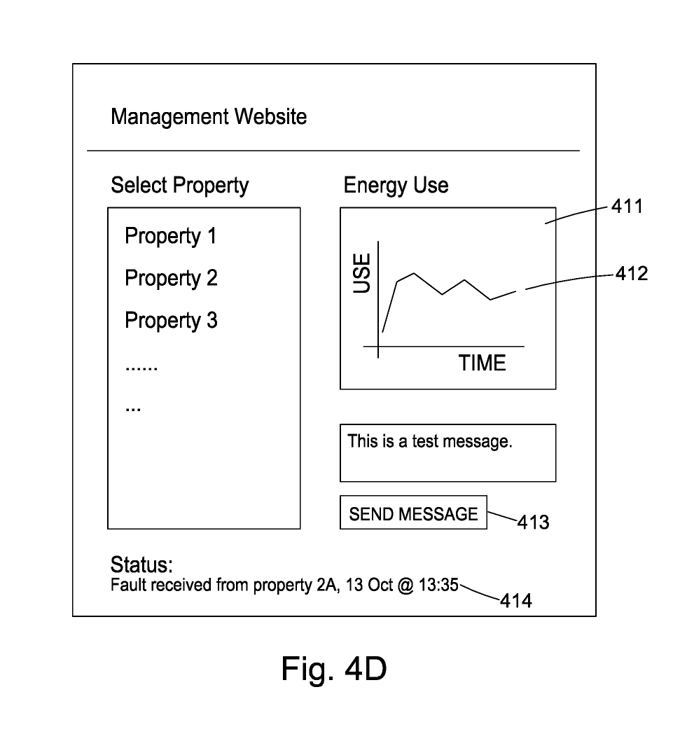

FIG. 4 is a schematic representation showing example user interface layouts which can be used with an illustrative embodiment of the present invention.

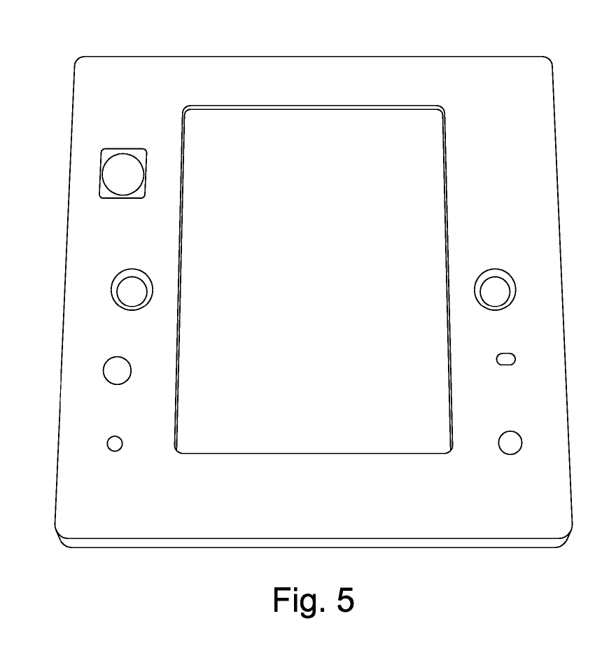

FIG. 5 shows a front view of a housing in accordance with an embodiment of the invention.

FIG. 6 shows a technical view of an embodiment of the invention.

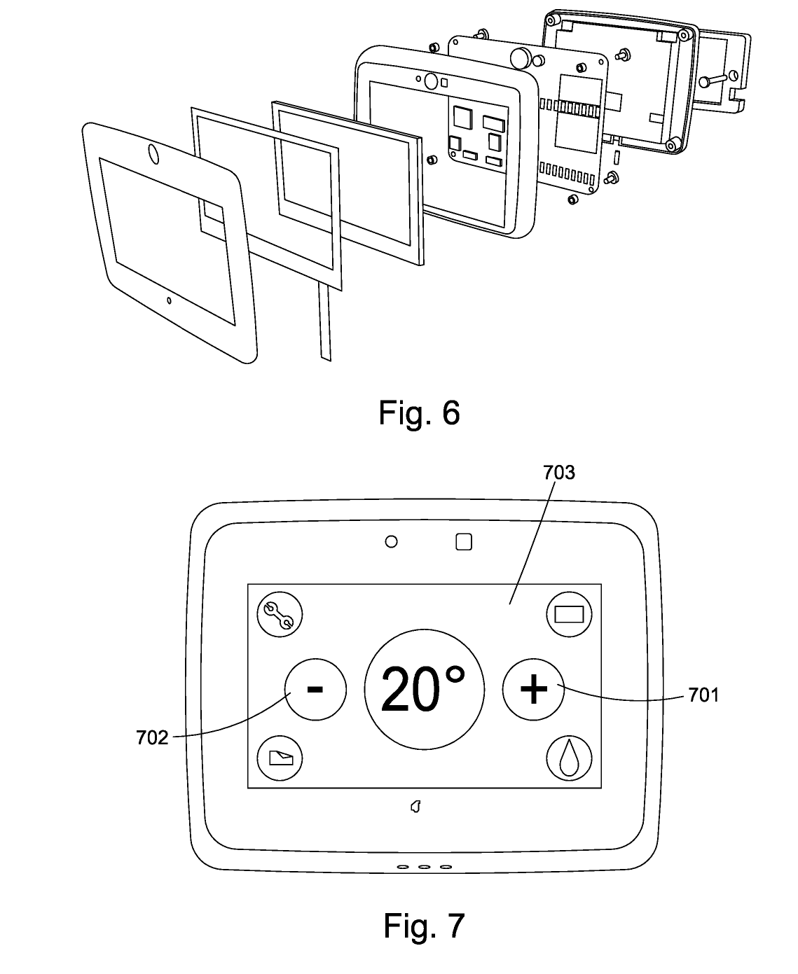

FIG. 7 shows a screen display in accordance with an embodiment of the invention.

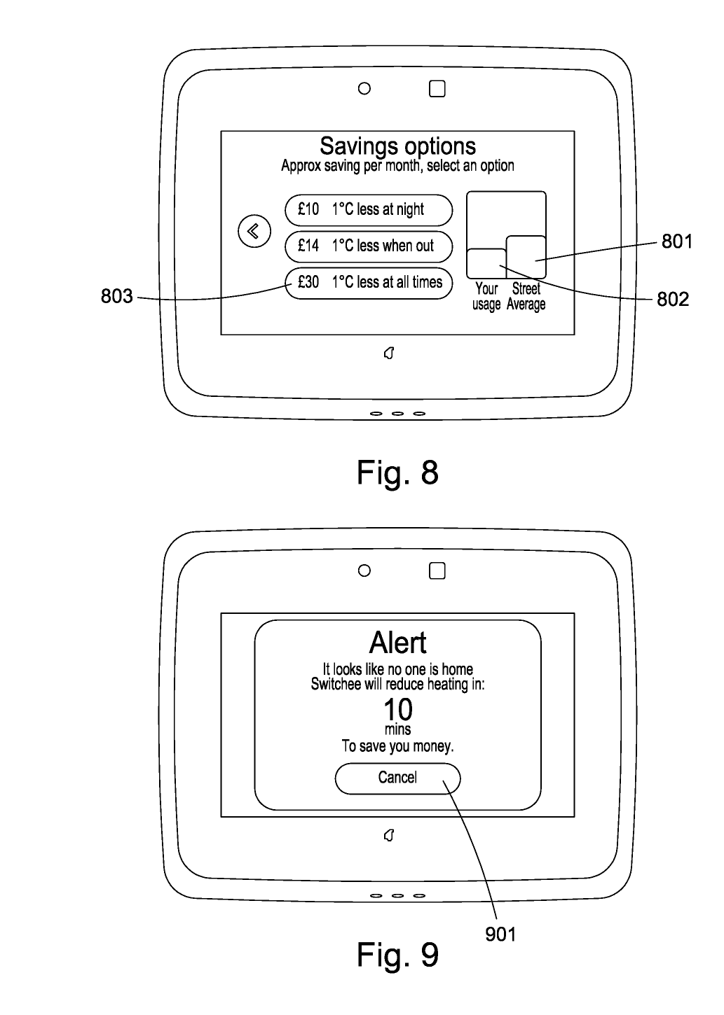

FIG. 8 shows a screen providing suggestions for reducing energy consumption.

FIG. 9 shows an alert notification being displayed on a screen of a unit in accordance with an illustrative embodiment of the invention.

FIG. 1 shows an illustrative embodiment of the invention. FIG. 1 shows a number of interfaces and sensors which are integrated into a single unit comprising two separate sub-assemblies 113 and 114 which attach to the building via bolts 111.

Fixed building infrastructure often includes a pattress box (which may also be referred to as a ‘switch box’, ‘wiring box’ or ‘device box’), 112, mounted in the wall cavity. The invention can be designed to fit into an enclosure for connection of the invention to the wall. This enclosure may simply be an aperture in a wall, or it could comprise a housing such as a pattress, knockout, dry lining, or wall box. The housing may be designed for mounting on the surface of the wall, or at least partially inside the wall. The invention may therefore be designed so that it can be accommodated within a pattress or other housing, or to mate with the housing in some way. The dimensions of the invention may be selected according to the dimensions of a standard sized pattress or wiring box as used in a particular country. The invention can replace an existing light switch, socket or thermostat which has been previously mounted in or on the wall so that the invention is able to dock directly with existing wall infrastructure and connect to existing wiring to control the energy consuming device.

This may optionally provide several advantages or benefits. Firstly, the invention is easy to install because it can simply replace an existing switch, socket or thermostat or other electrical actuator. Secondly, it does not consume significant additional space in or on the wall which may be undesirable due to practical constraints or because it may be aesthetically unpleasing. Thirdly, it allows the invention to connect to the existing electrical system and so further wiring and electrical connectivity does not need to be introduced. This reduces installation time as well as cost.

The head unit 114 includes a number of sensors and outputs—a passive infra-red movement sensor 121, ambient light sensor 122, humidity and temperature sensor 120, touchscreen 123, speaker 118, LEDs 119 (obscured behind thinner section of the enclosure wall), microphone and sound processor 325, a Carbon Dioxide sensor 326 and various other gas sensors 326. Internal to this head unit 114 are further sensors (for example, pressure, sound, gas or radio frequency receivers), communication devices and a microprocessor. This head unit 114 attaches to the interface sub-assembly 113 by way of mechanical clips 116. An electrical interface between the head unit 114 and interface sub-assembly 113 is achieved via connectors 115 and 117. Internal to the interface sub-assembly 113 are power supply and actuation components. An interface to the residential electrical system is achieved via cabling 125 connected to terminal blocks 124 within the interface sub-assembly. An additional receiver unit 126 communicates wirelessly with the head unit 114. This receiver unit connects directly to the residential heating system via cabling 127 where cabling for the residential heating or cooling system is not already collocated with the main unit.

The head unit 114 includes switches within it that are actuated when the entire head unit is pivoted or depressed by the user. Such an interaction would then signal to the controller to turn an attached light on or off.

FIG. 2 shows an alternative embodiment of the invention. The numbering scheme is identical to that of FIG. 1.

FIG. 3 shows a functional block diagram of the electronic system which underpins the invention. Central to the system is a microprocessor 324. This receives inputs from a number of discrete sensors—a clock 300, a temperature sensor 301, a humidity sensor 302, a pressure sensor 303, an ambient light sensor 304, an infra-red receiver unit 305, a passive infra-red movement sensor 306 and an external contact or reed switch based sensor 307. Other instantiations may include additional sensors—for example pressure, sound, gas or radio frequency receivers). The information from these sensors is collated and processed by the microprocessor and stored within memory 324. The microprocessor 324 makes decisions based upon this data which can result in it controlling a number of different outputs—relay units 320 or dimmer units for lighting 321.

The microprocessor 324 is also able to communicate with other devices via a number of different protocols 308 309 and 310. It can also receive and act upon messages received from other devices. An interface with the user is provided via an electronic colour display 315 onto which there is mounted a touch panel 313. Further user inputs are available via a three dimensional gesture control system that uses sensors 314 positioned beneath the front panel of the unit, ‘buttons’ 312 which sense user proximity through capacitive sensing and mechanical buttons 311. The microprocessor 324 can also synthesise audible frequencies and output these to an amplifier 323 which is subsequently connected to a speaker 322. Finally, an infra-red transmitter 316 can be controlled by the microprocessor 324.

Terminal blocks 319 provide mains power to the unit and interface the relays 320 or dimmer 321 with the high voltage devices (lighting or heating) under control. The mains power supplied through these terminal blocks 319 feeds a power supply 317 providing low voltage power to the rest of the electrical system. Power can also be harvested 318 from the lines supplying the devices controlled by the relays 320 and dimmer units 321. When the wiring that controls the heating system 127 or boiler is not already collocated with this unit, it is able to wirelessly transmit control data to a separate receiver 126 that is directly connected to wiring which in turn connects to the boiler.

Within the microprocessor 324 a series of intelligent algorithms statistically analyse sensor data to infer user behaviour. In particular, the invention combines inputs from multiple sensors to detect the presence of an occupant within the house. Additional data is gathered via communications devices 308 309 310 and included within the modelling.

Communications can be achieved both through Internet based protocols such as WiFi where an internet connection is available, or via a connection to the mobile phone SMS and data network where standalone functionality is important.

The microprocessor 324 is able to adapt its control model according to user behaviour, sensory inputs and user interface inputs. This provides a more intelligent control solution than is provided by the prior art. The electronic display 315 provides current system status information to the user, and provides a means of setting and configuring the unit to bespoke user requirements. Data is also sent back to a central processing unit or server where it is analysed, aggregated and used for the purposes described throughout.

During standard operation, multiple desired temperature profiles for the house are stored against times and days of the week. These are initially programmed using the interface described through FIG. 4, but adapt in response to observed user behaviour and user intervention. They can also be temporarily or permanently overridden by the user.

FIG. 4 provides example menu layouts for the user interface around which the invention is structured. These menus are displayed on the electronic display. The menu is controlled by one of the user input methods described previously. The user interface embodiment displayed in FIG. 4 relies on either the user touching the screen to select a button shown on the electronic display, or gesturing towards a button using the three dimensional gesture control function. Other embodiments could rely on capacitive sensors situated outside the perimeter of the electronic display that allow the user to navigate between options and make a selection on the menu system. The electronic display can be dimmed or deactivated to conserve power and be automatically re-activated when user presence is detected.

In general operation, the device controls the heating system with the aim of achieving a desired room temperature guided by a temperature-time profile. However, additional sensor readings, such as presence detection of the user, supplement this standard profile to ensure that the building or area is only heated when occupied and/or required. By adapting intelligently to user behaviour and presence, the unit is able to turn off heating and lighting systems when not required thereby saving significant quantities of energy.

FIG. 4a shows a typical layout for the ‘home screen’ 401 which is the default screen used when the device is offering a heating or cooling control function. The desired temperature 402 is shown in the centre of a ring 403 that changes colour depending on the status of the system. For example, the ring 403 might be coloured red when the device has activated the residential heating or cooling system to raise or lower the building temperature towards the desired temperature or green when the desired temperature has been reached. Other colours might indicate a system where the automatic temperature profile has been overridden by the user or a system which is currently off. Below the desired temperature 402, the system displays future activity 404—perhaps the next event within the temperature profile. Where a time is displayed this could be a countdown, to avoid the need for the user to know the current time or to set an on-board clock. In certain scenarios, the ring itself counts down the progress made against reaching the desired temperature target by displaying a series of ‘bars’ or ‘segments’ 405 which gradually reduce in number to zero at the point where the desired temperature is reached. Only two buttons are provided—a button indicating that the user is hot 406 which reduces the current desired temperature, and a button that indicates that the user is cold 407 which increases the current desired temperature. When the desired temperature is changed in this manner, the automatic temperature profile within the system is temporarily overridden until the next relevant point within the automatic temperature profile is reached. From this ‘home screen’ 401 the user can move left or right to other screens through a button press or swipe on the touchscreen. The menus are displayed cyclically such that if the user keeps moving in one direction they eventually return back to the home screen. Examples of these other menu systems are shown through FIG. 4b.

The messaging menu 411 provides notification of new messages sent to the unit by an external agent such as the property manager to be read by the building occupant. Previous messages can be recalled, deleted or saved.

A programming menu such as 412 allows the user to program the standard temperature-time profile. This can be achieved either by entering specific time-temperature data points of through simple lifestyle questioning. In the latter case, the user could be asked if they work, when they work, whether they have children (and of what age) and whether they would prefer a profile optimised for energy saving or comfort. From the results of this questioning, the unit is able to suggest an optimum temperature profile is postulated to the user to be accepted or modified.

A property management menu such as 413 allows the user to report faults 414 to the property manager for resolution. The user is also able to access their rental account 415 and see payment history and expected future payments. A variety of other menus are also available, for example, to control the hot water system 416.

As shown in FIG. 4c, in this embodiment of the invention, the user is able to touch a light bulb symbol 408 below the main electronic display 409 to access lighting control functionality. This automatically toggles the primary lighting system either on or off if it is connected and configured. Such lighting systems are generally connected directly to terminal blocks on the unit as described in FIG. 3, 319. Touching the light bulb symbol 408 also automatically loads the lighting control screen 410 so that the user can control other lights via wireless protocols.

Finally, FIG. 4d shows the management tools available to a property manager who is controlling multiple properties each of which has one of the units installed. Each individual unit exchanges information with this management tool so that it can gather a complete data set to assist with managing the properties and interacting with the tenants or building occupants. The management tool displays a variety of metrics 411 such as the comparative energy usage of the properties 412, allows control of the messaging functionality 413 (to send or receive messages from the unit or occupant), and it receives fault reports registered via the unit 414. Numerous other services and data are available via this dashboard.

The device has been designed so that installation is quick and simple. The user simply removes the existing light switch or thermostat from the wall. They detach the wires (usually live, switched live, neutral—although many other combinations are possible, including those without a local neutral connection) from the previous light switch or thermostat and attach them to the interface sub-assembly 113. The interface sub-assembly 113 is then bolted to the pattress or surface wall box which originally mated with the light switch or thermostat. Finally the device head-unit 114 is attached to the interface sub-assembly 113.

FIG. 6 shows an embodiment of a unit in accordance with the invention, and its various components. FIG. 7 shows an illustration of an embodiment in use. The background 703 is yellow to encourage the user to turn the heating down from 20 degrees. The user can control the temperature using the +icon 701 or −icon 702 to turn the temperature up or down respectively.

FIG. 8 shows an embodiment in use, wherein the invention is displaying options for saving energy (and thus costs). The screen provides an indication of the user's energy usage 802 along with an indication of the average consumption for the street or associated buildings 801. The screen also provides energy saving control options 803 such as “1 degree cooler at night”, “1 degree cooler when not in the building” or “1 degree cooler at all times”. The options include an indication of their approximate savings in costs.

FIG. 9 shows an alert notification being displayed on a screen of the unit, informing the user that the control system is about to reduce the heating in ten minutes because the system has detected that no one is home. The user can cancel this impending action using the cancel button 901.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A control system for intelligently controlling at least two energy consuming devices within a building, comprising:
a switch or computer-implemented control component for controlling a first energy consuming device; and
a computer-implemented control component for intelligently controlling at least one further energy consuming device,
wherein each of these switch or control components are provided within a housing; the system further comprising software arranged to generate one or more rules for controlling the first energy consuming device and/or further energy consuming device in accordance with a behavioural pattern relating to an occupant of a building.

2. A control system according to claim 1 wherein the first and or at least one further energy consuming device is a lighting device or a heating, ventilation or air conditioning device, or a security device, or a water heater.

3. A control system according to claim 1 wherein the system is arranged and configured to generate and/or store a thermal profile of the building or part thereof, the thermal profile providing an indication of the length of time required to heat the building or part thereof from an initial temperature to a target temperature.

4. A control system according to claim 1 wherein the housing is provided within a pattress or wiring box.

5. A control system according to claim 1, wherein the system is arranged to generate the behavioural pattern relating to the occupant, the pattern being generated using data derived from at least one sensor provided at or in the building.

6. A control system according to claim 1, wherein the control component comprises a microprocessor and suitably arranged software configured to receive sensor and/or user input data obtained from one or more sensors provided in or on the housing, and process the sensor and/or occupant behaviour data to enable the system to intelligently and/or parametrically control the at least one further energy consuming device.

7. A control system according to claim 1, wherein the control component is configured to communicate wirelessly with a receiver connected to the first and/or at least one further device to control its operation.

8. A control system according to claim 1, and further comprising:
i) input means to enable a user to provide input to the system, preferably wherein the input means comprises a touchscreen, electro-mechanical switch, motion sensor and/or microphone; and/or
ii) presentation means for presenting information to a user, preferably wherein the presentation means comprises a display screen and/or a speaker.

9. A control system according to claim 1, wherein the system is arranged and configured to detect mould growth or environmental factors favourable to mould growth, preferably wherein the system is arranged to provide an alert upon detection of the mould growth or favourable conditions.

10. A control system according to claim 1, and further comprising means for connecting to an electrical circuit provided within the infrastructure of the building such that the system is able to draw upon power from the circuit.

11. A control system according to claim 1, wherein the housing is mounted in or on a building infrastructure such as a wall.

12. A control system according to claim 1, and further comprising communications means for sending and receiving data via a telecommunications network.

13. A control system according to claim 1, wherein the system is arranged and configured to monitor for activity such as movement or device usage within the building, and generate an alert when no activity has been detected within a predetermined period of time.

14. A control system according to claim 1, where the system is arranged and configured to detect when a device is not performing as expected and generate an alert to a remote location; preferably wherein the device is a boiler or heating related apparatus.

15. A control system according to claim 1, where the system is arranged and configured to assess when the building is likely to be occupied and/or not occupied.

16. A control system according to claim 15, wherein the system is arranged to include or integrate with a scheduling system, such as a system for scheduling technician visits.

17. A control system according to claim 1, where the system is arranged and configured to provide an estimate or measurement of the thermal insulation quality within the building.

18. A control system according to claim 17 wherein the system is arranged to generate an alert if the estimate or measurement of thermal insulation quality falls below a predetermined threshold.

19. A control system according to claim 1, where the system is arranged and configured to record how many personnel visits the building has required within a predetermined period of time, and generate an alert when the number of visits within the period reaches a predetermined threshold.

20. A control system according to claim 1, where the system is arranged and configured to generate at least one suggestion for reducing the amount of energy consumed by the first and/or at least one further energy consuming device.

21. A control system according to claim 1, where the system is arranged and configured to arranged to enable a communication to be transmitted between the building and a remotely located control centre.

22. A control system according to claim 21 wherein the control arrangement comprises:
an interface arranged to enable a user of the building to input data for transmission to the control centre, the transmission of sensor data, and/or an interface arranged to enable a communication from the control centre to be presented to the user at the dwelling.

23. A control system according to claim 1, wherein the system is arranged to collect data from at least one sensor, and use the data to measure and/or record occupancy rates within the building or part thereof.

24. A control system according to claim 1, wherein the system is arranged to present information relating to energy consumption within the building in a colour coded manner so as to influence occupant behaviour.
